(19) United States
(12) Patent Application Publication
(10) Pub. No.: US 2013/0042744 A1
(43) Pub. Date: Feb. 21, 2013

(54) SILENT DRUMHEAD

(71) Applicant: Chao-Ying Hsien, Hemei Township (TW)

(72) Inventor: Chao-Ying Hsien, Hemei Township (TW)

(21) Appl. No.: 13/211,287

(22) Filed: Aug. 16, 2011

(51) Int. Cl. G10D 13/02

(52) U.S. Cl. 84/414

(57) ABSTRACT

A silent drumhead, comprising:
more than one layer of thin-film drumhead having a plurality of through-holes distributed throughout thereon;
wherein the silent drumhead is formed by laminating the more than one layer of thin-film drumhead together; and
wherein the more than one layer of thin-film drumhead are adhered together by means of an adhesive layer(s) therebetween.

By using the plurality of through-holes to exhaust the air underneath the drumhead, vibrations generated when the drumhead is beaten are effectively reduced. This can mitigate the acoustic resonant effect of the drum shell to reduce the sound level when the drumhead is beaten. Furthermore, the thin-film drumheads that have been used in conventional drums can feed back the touch sense of beating in a totally realistic way to effectively overcome the shortcoming of conventional woven silent drumheads that they provide poor touch sense of beating.

### BACKGROUND OF THE INVENTION

1. Technical Field

The present invention relates to the field of musical instruments, and more particularly, to a silent drumhead formed by laminating thin-film drumheads used in conventional drums.

2. Description of Related Art

Nowadays, jazz drums have become much popular in the drum kit market, but the loud sound thereof sometimes cause a great trouble to the neighbors. Then, with the advent of electronic drums, this problem seems to be solved. An electronic drum uses a beater plate instead of a drum shell and a drumhead, and uses a pickup to pick up beating signals. The beating signals are transmitted to an audio host for processing and are then played through an earphone worn by the drummer or through a speaker.

However, the beater plate is unable to provide the same touch sense of beating as that of a real drumhead, so it is impossible for the drummer to experience and appreciate the sense of beating of a real drumhead. This has an adverse influence on the beating effect.

To solve this problem, silent drumheads have come into market. The silent drumheads can reduce the sound level of the drum when being beaten, so they can deliver an effect of reducing the noise caused to the environment.

Silent drumheads currently available are all formed through weaving. However, as being limited by the material thereof, this kind of silent drumheads are unable to be tensioned completely. Therefore, although the drumbeats thereof can be picked up by a pickup and transmitted an audio host for correction, the touch sense of beating thereof is still much poorer than that of a real drumhead and efforts still have to be made to solve this problem.

Conventional silent drumhead structures already known include those disclosed in U.S. Pat. No. 6,525,249 and 6,784,352. Each of those silent drumhead structures comprises a drumhead which partly has through-holes formed therein, and particularly, a vibration absorption element is further attached on a back surface of the drumhead. The operating principle thereof is as follows: by attaching the vibration absorption element onto the back surface of the drumhead, the vibrations generated when the drumhead is beaten can be absorbed without causing acoustic resonance in the drum shell; and in this way, an effect of silencing the drumhead can be achieved. However, as is known from experiences in practical use, the drumhead of this structure lacks an adequate strength and is unable to withstand the beating force of the drummer, so it is liable to damage; furthermore, the vibration absorption element attached on the back surface of the drumhead will inevitably have an influence on the touch sense of beating felt by the drummer Accordingly, it is obvious that this kind of silent drumhead structure is not an ideal silent drumhead structure.

### BRIEF SUMMARY OF THE INVENTION

An objective of the present invention is to overcome the shortcoming of the conventional woven silent drumheads that they cannot provide a touch sense of beating comparable to that of a real drumhead. To achieve this objective, a silent drumhead is disclosed in the present invention, which comprises:

more than one layer of thin-film drumhead having a plurality of through-holes distributed throughout thereon;

wherein the silent drumhead is formed by laminating the more than one layer of thin-film drumhead together; and

wherein the more than one layer of thin-film drumhead are adhered together by means of an adhesive layer(s) therebetween.

By using the plurality of through-holes to exhaust the air underneath the drumhead, vibrations generated when the drumhead is beaten are effectively reduced. This can mitigate the acoustic resonant effect of the drum shell to reduce the sound level when the drumhead is beaten. Furthermore, the thin-film drumheads that have been used in conventional drums can provide a touch sense of beating in a totally realistic way to effectively overcome the shortcoming of conventional woven silent drumheads that they provide poor touch sense of beating.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic outside view of a silent drumhead according to an embodiment of the present invention;

FIG. 2 is an enlarged partial view of a thin-film drumhead structure according to an embodiment of the present invention;

FIG. 3 is a schematic view of a composite structure of the silent drumhead according to an embodiment of the present invention; and

FIG. 4 is another schematic view of a composite structure of the silent drumhead according to an embodiment of the present invention.

| | |
|---|---|
| 1 Silent drumhead | |
| 2 Thin-film drumhead | 21 Through-hole |
| 3 Adhesive layer | |

### DETAILED DESCRIPTION OF THE INVENTION

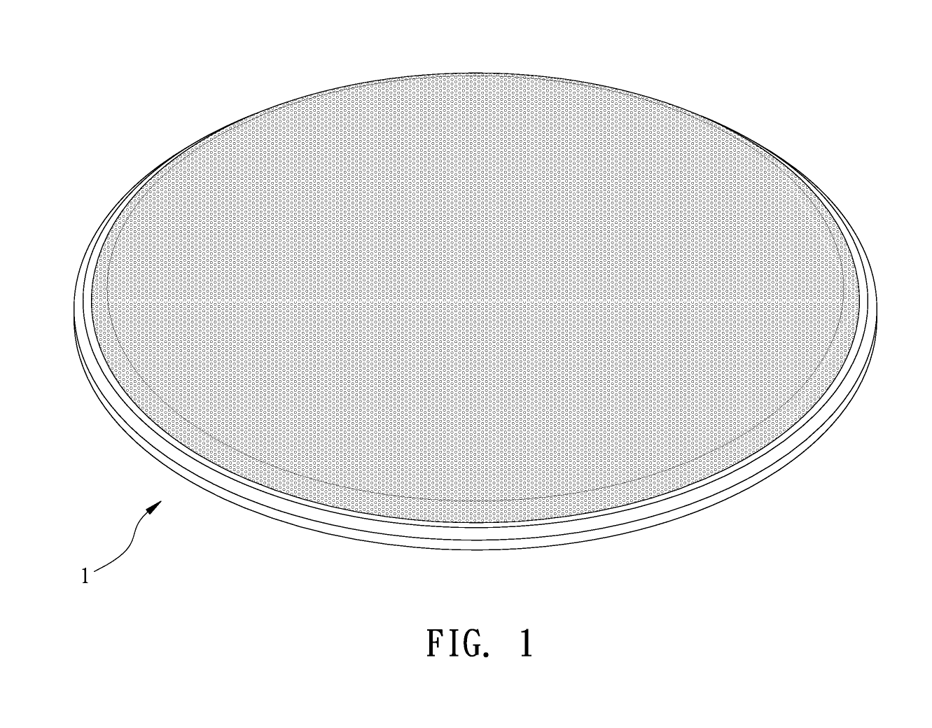

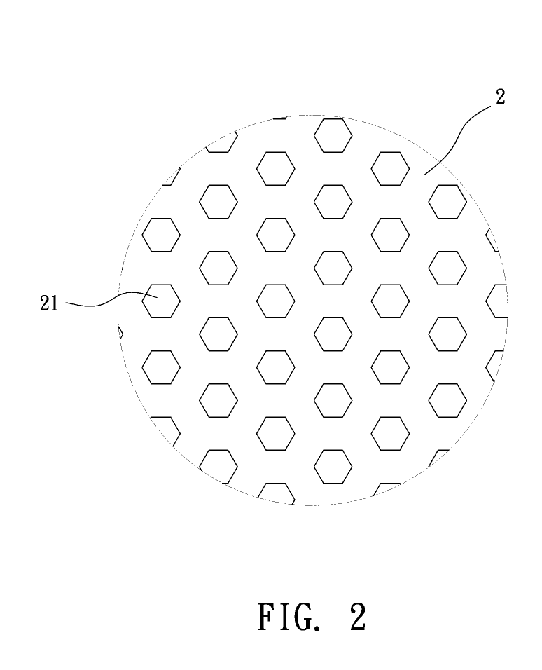

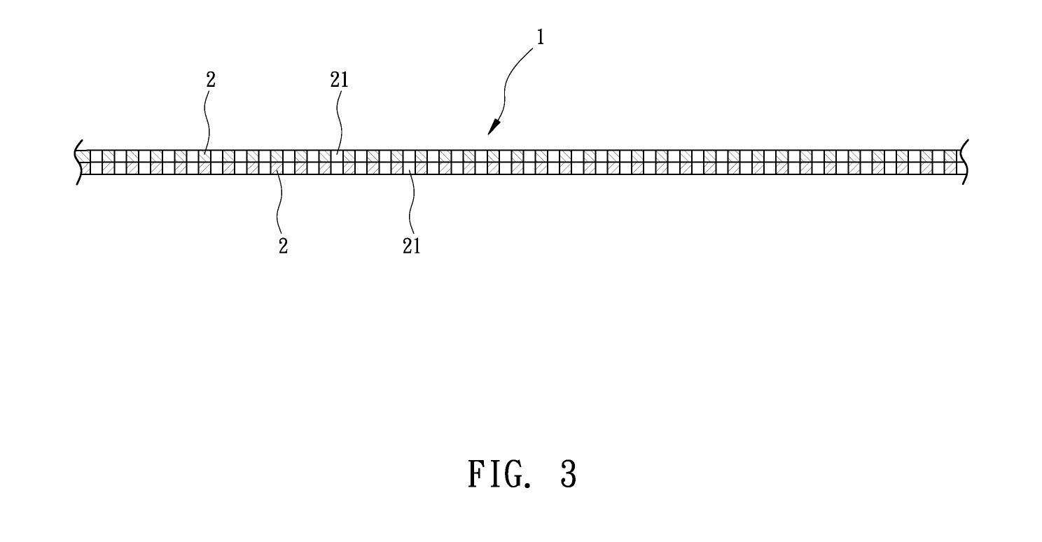

Referring to FIG. 1, FIG. 2 and FIG. 3, a silent drumhead 1 of the present invention comprises:

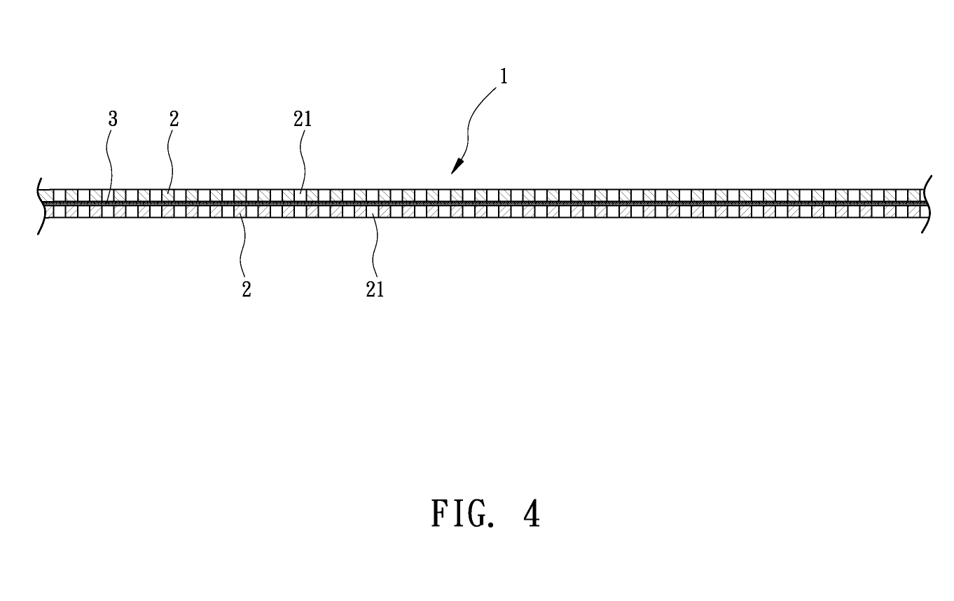

more than one layer of thin-film drumhead 2 having a plurality of through-holes 21 distributed throughout thereon;

wherein the silent drumhead 1 is formed by laminating and adhering the more than one layer of thin-film drumhead 2 together by means of an adhesive layer(s) 3 therebetween, as shown in FIG. 4; and

wherein the thin-film drumheads 2 are conventional ones, and the plurality of through-holes 21 are formed through processing on the drumheads.

Thus, by using the plurality of through-holes 21 to exhaust the air underneath the drumhead, vibrations generated when the drumhead is beaten are effectively reduced. This can mitigate the acoustic resonant effect of the drum shell to reduce the sound level when the drumhead is beaten. Furthermore, when being beaten, the thin-film drumheads 2 that have been used in conventional drums can provide a touch sense of beating in a totally realistic way to effectively overcome the shortcoming of conventional woven silent drumheads that they provide poor touch sense of beating.

The composite structure comprised of a plurality of layers can further ensure the structural strength of the silent drumhead 1 and is less liable to damage by an external force. Furthermore, through use of the adhesive layer(s) 3 disposed between the layers, the composite structure can be further strengthened so that adjacent thin-film drumheads 2 will not collide against each other to make abnormal sounds when being beaten.

What is claimed is:

1. A silent drumhead, comprising:
more than one layer of thin-film drumhead having a plurality of through-holes distributed throughout thereon;
wherein the silent drumhead is formed by laminating the more than one layer of thin-film drumhead together.

2. The silent drumhead of claim 1, wherein the more than one layer of thin-film drumhead are adhered together by means of an adhesive layer(s) therebetween.
